(19) United States
(12) Patent Application Publication
(10) Pub. No.: US 2012/0212415 A1
(43) Pub. Date: Aug. 23, 2012

(54) INTERACTIVE SYSTEM, METHOD FOR CONVERTING POSITION INFORMATION, AND PROJECTOR

(75) Inventor: Minoru Yokobayashi, Matsumoto-shi (JP)

(73) Assignee: Seiko Epson Corporation, Tokyo (JP)

(21) Appl. No.: 13/371,664

(22) Filed: Feb. 13, 2012

(30) Foreign Application Priority Data
Feb. 21, 2011 (JP) 2011-034269

(51) Int. Cl. G06F 3/033

(52) U.S. Cl. 345/158

(57) ABSTRACT

A position information converting device in an interactive system comprising: conversion control section which determines, if an image formed by an optical signal from an object of the neighborhood of the projection surface is detected within the projection image included in the captured image data, that the predetermined manipulation has been performed, uses the position conversion information stored in the position conversion information storing section to convert position information representing the position where the predetermined manipulation has been performed into a position on the image based on the image signal.

### BACKGROUND

1. Technical Field

The present invention relates to an interactive system, a method for converting position information, and a projector.

2. Related Art

Recently, a system has been proposed in which an image based on an image signal output from a computer is projected by a projector onto a whiteboard or the like and the image projected (projection image) is captured by an image capturing device (camera) to recognize, by the computer, a user's manipulation performed on the projection image (for example, refer to JP-A-2005-353071).

For realizing a correct manipulation in the system described above, after installing the projector and the image capturing device, it is necessary to implement a procedure (calibration) for bringing a predetermined place within the projection image into correspondence with a predetermined place within the image based on the image signal. For example, a form has been known in which a user is caused to point a predetermined position within the projection image, while capturing the projection image with the image capturing device, to implement the calibration.

In such a system, a user sometimes changes the computer to be used. In this case, when the resolution of the image output from the computer changes, the area of an image to be projected onto a whiteboard is changed. Therefore, a correspondence of position between the projection image and the image based on the image signal is deviated, making it impossible to realize a correct manipulation. Therefore, the user has to implement the calibration again.

### SUMMARY

An advantage of some aspects of the invention is to solve at least a part of the problems described above, and the invention can be implemented as the following modes or application examples.

### APPLICATION EXAMPLE 1

An interactive system according to this application example includes: a projector; a computer which supplies the projector with an image signal; and a transmitter which transmits a light signal based on a predetermined manipulation, wherein the projector includes an image signal input section to which the image signal is input, a light source, an image projecting section which modulates, according to the image signal, light emitted from the light source to project the light onto a projection surface as a projection image, a resolution determining section which determines the resolution of an image based on the image signal to output resolution information, and a position information converter which performs, based on the image signal, conversion of information of a position where the predetermined manipulation has been performed, the position information converter includes an image capturing section which captures a range including the projection image to output captured image data, a calibration control section which calculates position conversion information so as to bring a predetermined place within the projection image represented by the captured image data into correspondence with a predetermined place within the image based on the image signal, a position conversion information storing section which stores the position conversion information resolution by resolution based on the resolution information, a conversion control section which determines, if an image formed by the light signal is detected within the projection image included in the captured image data, that the predetermined manipulation has been performed, uses the position conversion information stored in the position conversion information storing section to convert position information representing the position where the predetermined manipulation has been performed into a position on the image based on the image signal, and outputs the position information, and a converted position information output section which outputs the position information converted by the conversion control section, and the computer includes an object manipulating section which manipulates, based on the position information output by the converted position information output section, an object included in the image represented by the image signal.

According to the interactive system described above, the projector, the computer, and the transmitter are included. The projector includes the image signal input section, the image projecting section, the resolution determining section, and the position information converter. The projector projects a projection image onto a projection surface based on an image signal input from the computer. At this time, the projector determines the resolution of the image signal. The position information converter includes the image capturing section, the calibration control section, the position conversion information storing section, the conversion control section, and the converted position information output section. The image capturing section captures a range including the projection image to output captured image data. The position information converter stores, when calibration is implemented, position conversion information which brings a predetermined place within the projection image into correspondence with a predetermined place within the image based on the image signal, in the position conversion information storing section resolution by resolution. The conversion control section determines, if an image formed by the light signal is detected within the projection image included in the captured image data, that a predetermined manipulation has been performed, uses the position conversion information to convert position information representing a position where the predetermined manipulation has been performed into a position on the image based on the image signal, and outputs the position information. The converted position information output section outputs the converted position information. The computer manipulates an object included in the image represented by the image signal based on the position information output by the converted position information output section. With this configuration, the position conversion information is stored resolution by resolution in the position conversion information storing section of the position information converter. Therefore, in the interactive system, when the computer is changed, if position conversion information corresponding to the same resolution has been stored in the position conversion information storing section, the position conversion information can be used to convert position information. Accordingly, since it is no necessary to implement calibration again, convenience is improved.

The conversion control section may cause the converted position information output section to output notification for prompting the implementation of calibration if the position conversion information corresponding to a resolution based on the resolution information has not been stored in the position conversion information storing section. With this configuration, the computer can recognize that it is necessary to implement calibration. Then, since it is possible to notify a user of the need, convenience is improved.

The position conversion information may be a conversion expression. This can simplify a position converting process.

When the computer is changed, if the position conversion information corresponding to the same resolution has been stored by the step of storing position conversion information, the position conversion information can be used to convert position information. Accordingly, since it is no necessary to implement calibration again, convenience is improved.

Moreover, if position conversion information corresponding to a resolution based on resolution information has not been stored in the position conversion information storing section, notification for prompting the implementation of calibration is output. With this configuration, the computer can recognize that it is necessary to implement calibration. Then, since it is possible to notify a user of the need, convenience is improved.

Moreover, the position conversion information is a conversion expression. This can simplify a position converting process.

Moreover, when the resolution of an input image signal is changed, if position conversion information corresponding to the same resolution has been stored in the position conversion information storing section, the position conversion information can be used to convert position information.

When the interactive system and the projector described above and a method for converting position information according to the invention are constructed using the computer included in the position information converter or the projector, the modes or application examples described above can be configured in the form of a program for implementing the functions of the modes or application examples, or a recording medium on which the program readable by the computer is recorded. As the recording medium, it is possible to use various kinds of media readable by the computer, such as a flexible disk or HDD (Hard Disk Drive), a CD-ROM (Compact Disk Read Only Memory), a DVD (Digital Versatile Disc), a Blu-ray Disc (registered trademark), a magneto-optical disc, a nonvolatile memory card, an internal storage device (semiconductor memory such as a RAM (Random Access Memory) or a ROM (Read Only Memory)) of the position information converter or the projector, and an external storage device (USB memory etc.).

### BRIEF DESCRIPTION OF THE DRAWINGS

The invention will be described with reference to the accompanying drawings, wherein like numbers reference like elements.

FIG. 1 is a block diagram showing a configuration of an interactive system according to an embodiment.

FIG. 2 is an explanatory diagram of a position conversion information storing section.

FIG. 3 is a sequence diagram of a PC and a projector in calibration.

FIGS. 4A and 4B are each an explanatory diagram of an image in calibration, in which FIG. 4A is an explanatory diagram of a projection image of a first calibration point and FIG. 4B is an explanatory diagram of a captured image at the time of first calibration.

FIGS. 5A and 5B are each an explanatory diagram of an image in calibration, in which FIG. 5A is an explanatory diagram of a projection image of a ninth calibration point and FIG. 5B is an explanatory diagram of a captured image at the time of ninth calibration.

FIG. 6 is a flowchart of a process performed by the projector when the interactive system is activated.

FIG. 7 is a sequence diagram when the interactive system executes a position converting process.

### DESCRIPTION OF EXEMPLARY EMBODIMENTS

Hereinafter, an embodiment will be described.

In the embodiment, an interactive system will be described in which a projection image is captured and a position where a predetermined manipulation is performed within the projection image is detected based on a captured image.

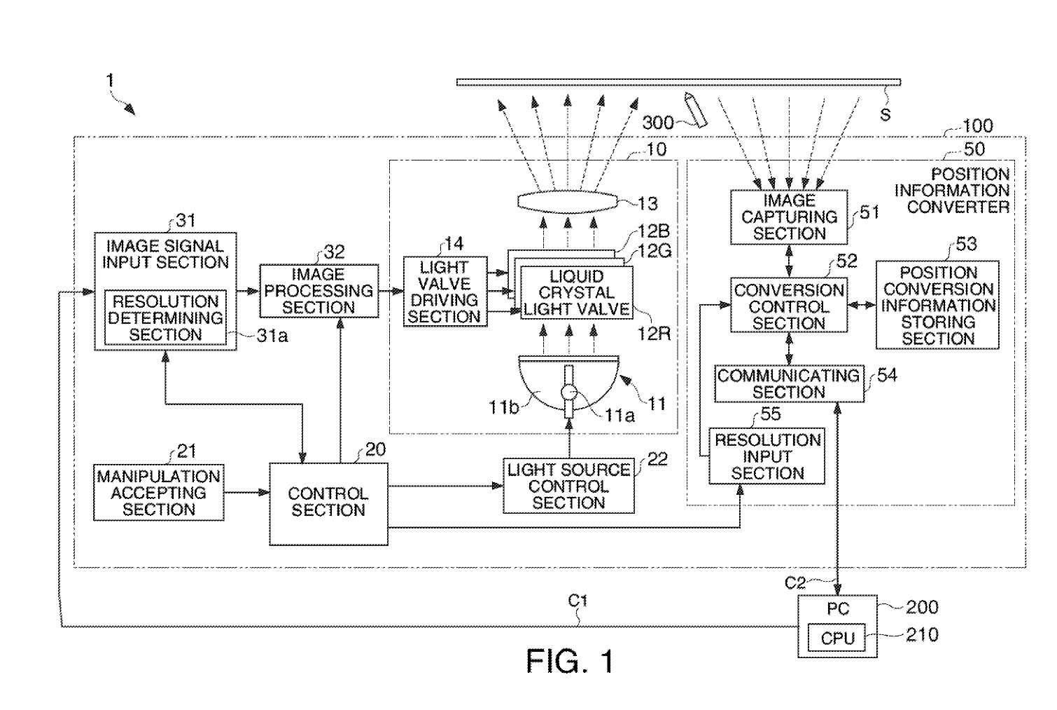

FIG. 1 is a block diagram showing a configuration of the interactive system according to the embodiment. As shown in FIG. 1, the interactive system 1 is configured to include a projector 100, a personal computer (PC) 200, a light-emitting pen 300 as a transmitter which transmits alight signal, and a projection surface S such as a whiteboard.

The projector 100 is configured to include an image projecting section 10, a control section 20, a manipulation accepting section 21, a light source control section 22, an image signal input section 31, an image processing section 32, and a position information converter 50.

The image projecting section 10 includes a light source 11, three liquid crystal light valves 12R, 12G, and 12B as a light modulator, a projection lens 13 as a projection optical system, and a light valve driving section 14. The image projecting section 10 modulates light emitted from the light source 11 with the liquid crystal light valves 12R, 12G, and 12B to form image light and projects the image light from the projection lens 13 to display the image light on the projection surface S or the like.

The light source 11 is configured to include a discharge-type light source lamp 11a formed of an extra-high-pressure mercury lamp, a metal halide lamp, or the like and a reflector 11b reflecting light radiated by the light source lamp 11a to the side of the liquid crystal light valves 12R, 12G, and 12B. The light emitted from the light source 11 is converted by an integrator optical system (not shown) into light whose brightness distribution is substantially uniform, and separated by a color separation optical system (not shown) into respective color light components of red R, green G, and blue B which are three colors of light. Thereafter, the three color components are incident on the liquid crystal light valves 12R, 12G, and 12B, respectively.

The liquid crystal light valves 12R, 12G, and 12B are each composed of a liquid crystal panel or the like having liquid crystal sealed between a pair of transparent substrates. In the liquid crystal light valves 12R, 12G, and 12B, a plurality of pixels (not shown) arranged in a matrix form are formed, and a driving voltage can be applied to the liquid crystal pixel by pixel. When the light valve driving section applies a driving voltage according to input image information to each of the pixels, each of the pixels is set to have a light transmittance ratio according to the image information. Therefore, the light emitted from the light source 11 is modulated by transmitting through the liquid crystal light valves 12R, 12G, and 12B, and an image according to image information is formed for each of the color lights. The formed images of the respective colors are combined by a light combining optical system (not shown) pixel by pixel to be a color image, and thereafter the color image is projected from the projection lens 13.

The control section 20 includes a CPU (Central Processing Unit), a RAM. used for temporal storage and the like of various kinds of data, and a nonvolatile memory (all of which are not shown) such as a mask ROM, a flash memory, a FeRAM (Ferroelectric RAM: ferroelectric memory), and functions as a computer. With the CPU operating in accordance with control programs stored in the nonvolatile memory, the control section 20 integrally controls operation of the projector 100.

Moreover, the control section 20 receives resolution information of an image signal determined by a resolution determining section 31a included in the image signal input section 31, described later, and notifies the position information converter 50 of the resolution information.

The manipulation accepting section 21 accepts an input manipulation from a user and includes a plurality of manipulation keys with which the user gives the projector 100 various kinds of instructions. The manipulation keys included in the manipulation accepting section 21 include a power key for switching the power on and off, a menu key for switching the display and non-display of a menu screen for performing various kinds of settings, cursor keys used for moving a cursor and the like on the menu screen, and an enter key for entering various kinds of settings. When the user manipulates (presses) the various kinds of manipulation keys of the manipulation accepting section 21, the manipulation accepting section 21 accepts the input manipulation and outputs to the control section 20 a manipulation signal according to the content of the user's manipulation. The manipulation accepting section 21 may have a configuration in which a remote control (not shown) capable of remote-controlling is used. In this case, the remote control sends a manipulation signal, such as infrared rays, according to the content of the user's manipulation, and a remote control signal receiving section (not shown) receives the manipulation signal and transmits the signal to the control section 20.

The light source control section 22 includes an inverter (not shown) which converts a direct current generated by a power supply circuit (not shown) into an alternating rectangular wave current and an igniter (not shown) for promoting the starting of the light source lamp 11a by performing a breakdown between electrodes of the light source lamp 11a. The light source control section 22 controls the turning of the light source 11 based on an instruction of the control section 20. Specifically, the light source control section 22 can activate the light source 11 to be turned on by supplying predetermined power and can turn off the light source 11 by stopping the supply of the power. Moreover, the light source control section 22 can control the power to be supplied to the light source 11 based on an instruction of the control section 20 to thereby adjust the luminance (brightness) of the light source 11.

The image signal input section 31 is provided with an input terminal (not shown) for connecting with the PC 200 via a cable C1, so that an image signal is input from the PC 200. The image signal input section 31 converts the input image signal into image information in the form processable by the image processing section 32 and outputs the image information to the image processing section 32. Moreover, the image signal input section 31 notifies the control section 20 whether or not an image signal has been input. Further, the image signal input section 31 is provided with the resolution determining section 31a. The resolution determining section 31a determines the resolution of the image signal input to the image signal input section 31 and notifies the control section 20 of the determination as information of resolution (resolution information).

The image processing section 32 converts the image information input from the image signal input section 31 into image data representing the gray scales of the pixels of each of the liquid crystal light valves 12R, 12G, and 12B. In this case, the converted image data is composed of data of the respective R, G, and B color lights, and includes a plurality of pixel values corresponding to all the pixels of the liquid crystal light valves 12R, 12G, and 12B. The pixel value defines the light transmittance ratio of a corresponding pixel, and the intensity (gray scale) of light emitted from each pixel is defined by the pixel value. Moreover, the image processing section 32 performs, based on an instruction of the control section 20, an image quality adjusting process and the like for adjusting brightness, contrast, sharpness, hue, and the like on the converted image data and outputs the processed image data to the light valve driving section 14.

When the light valve driving section 14 drives the liquid crystal light valves 12R, 12G, and 12B in accordance with the image data input from the image processing section 32, the liquid crystal light valves 12R, 12G, and 12B form an image according to the image data, whereby the image is projected from the projection lens 13.

The position information converter 50 is configured to include an image capturing section 51, a conversion control section 52, a position conversion information storing section 53, a communicating section 54 as a converted position information output section, and a resolution input section 55.

The image capturing section 51 includes an image capturing device (not shown) composed of a CCD (Charge Coupled Device) sensor, a CMOS (Complementary Metal Oxide Semiconductor) sensor, or the like and an image capturing lens (not shown) for forming, on the image capturing device, an image of light emitted from an object to be captured. The image capturing section 51 is disposed in the vicinity of the projection lens 13 of the projector 100 and captures a range including an image (hereinafter also referred to as “projection image”) projected on the projection surface S at a predetermined frame rate. Then, the image capturing section 51 sequentially generates image information representing the image captured (hereinafter also referred to as “captured image”) and outputs the image information to the conversion control section 52.

The conversion control section 52 includes a CPU, a RAM used for temporary storage or the like of various kinds of data, and a nonvolatile memory (all of which are not shown) such as a mask ROM, a flash memory, or a FeRAM. With the CPU operating in accordance with control programs stored in the nonvolatile memory, the conversion control section 52 controls operation of the position information converter 50.

The conversion control section 52 uses position conversion information stored in the position conversion information storing section 53 to perform conversion of position information on the image information of the captured image input from the image capturing section 51, and outputs the converted information to the communicating section 54. Specifically, based on the image information of the captured image, it is determined whether or not the light-emitting pen 300 has emitted light within the image. Then, if there is emission of light, a position where the light has been emitted, that is, position information (coordinates) where the press manipulation of a press switch has been performed within the captured image is detected. When detecting the position information (coordinates) where the light has been emitted, the conversion control section 52 uses position conversion information determined by calibration to perform conversion from the position information on the captured image into position information on an image based on an image signal.

Upon receiving a request for performing calibration from the PC 200 via the communicating section 54, the conversion control section 52 implements calibration for making a correspondence of position between the projection image and the image based on the image signal while communicating with the PC 200.

The position conversion information storing section 53 is composed of a nonvolatile memory and stores position conversion information used by the conversion control section for converting position information. The position conversion information is written by the conversion control section 52 when calibration is implemented.

Here, the position conversion information storing section 53 will be described.

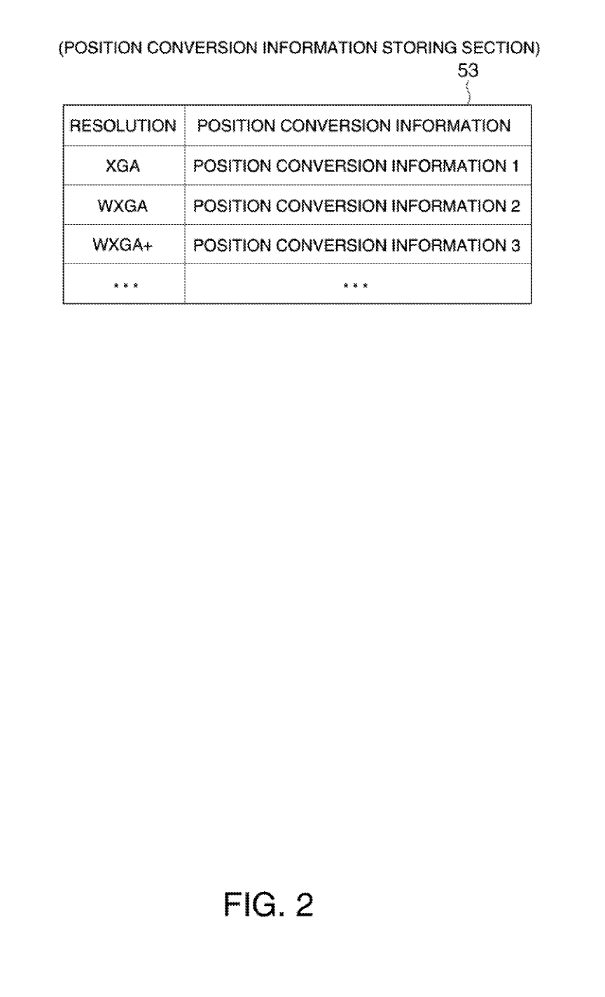

FIG. 2 is an explanatory diagram of the position conversion information storing section 53. As shown in FIG. 2, the position conversion information storing section 53 stores position conversion information (position conversion information 1, position conversion information 2, position conversion information 3, . . . ) for respective resolutions (XGA, WXGA, WXGA+, . . . ). In the embodiment, as the position conversion information, conversion information of coordinates between a projection position and a captured image position when calibration is implemented is stored. In this case, the conversion information of coordinates may be a conversion expression for coordinate conversion, or may be coordinate information as it is.

The communicating section 54 uses predetermined communication means to communicate with the PC 200 via a cable C2. Specifically, the communicating section 54 sends the position information (coordinate information) converted by the conversion control section 52 or receives calibration point information for calibration. The communicating section 54 performs communication based on an instruction of the conversion control section 52 and transmits received control information to the conversion control section 52. In the embodiment, the communication means used by the communicating section 54 is communication means using a USB (Universal Serial Bus). The communication means used by the communicating section 54 is not limited to a USB, but another communication means may be used.

The resolution input section 55 receives, from the control section 20, the resolution information of the image signal determined by the resolution determining section 31a of the image signal input section 31, and transmits the resolution information to the conversion control section 52.

The light-emitting pen 300 includes, at a tip (pen tip) of a pen-shaped main body, the press switch and a light-emitting diode which emits infrared light. When a user performs a manipulation (press manipulation) of pressing the pen tip of the light-emitting pen 300 onto the projection surface S to press the press switch, the light-emitting diode emits light.

In a storage device (not shown) of the PC 200, software (device driver) for using the light-emitting pen 300 like a pointing device is stored. In a state where the software is activated, the PC 200 recognizes, based on the position information (coordinate information) input from the communicating section 54 of the projector 100, a position where the light-emitting pen 300 has emitted light within the projection image, that is, a position where the press manipulation has been performed within the projection image. Then, an object included in the image is manipulated. A CPU 210 which performs software operation of the PC 200 at this time corresponds to the object manipulating section. When recognizing the position where the light has been emitted, the PC 200 performs the same process as when a click manipulation by a pointing device is performed at the position. In other words, a user can perform, by performing the press manipulation with the light-emitting pen 300 within the projection image, the same instruction as that performed with a pointing device on the PC 200.

Here, calibration will be described. In calibration in the embodiment, nine calibration point projection images are projected from the PC 200. A user performs a press manipulation at the calibration points on the projection surface S using the light-emitting pen 300. The projector 100 analyzes the captured image to detect the position (coordinates) where the press manipulation has been performed with the light-emitting pen 300, and makes a correspondence of position conversion (coordinate conversion) between position information within the projection image represented by the captured image and position information of an image based on an image signal.

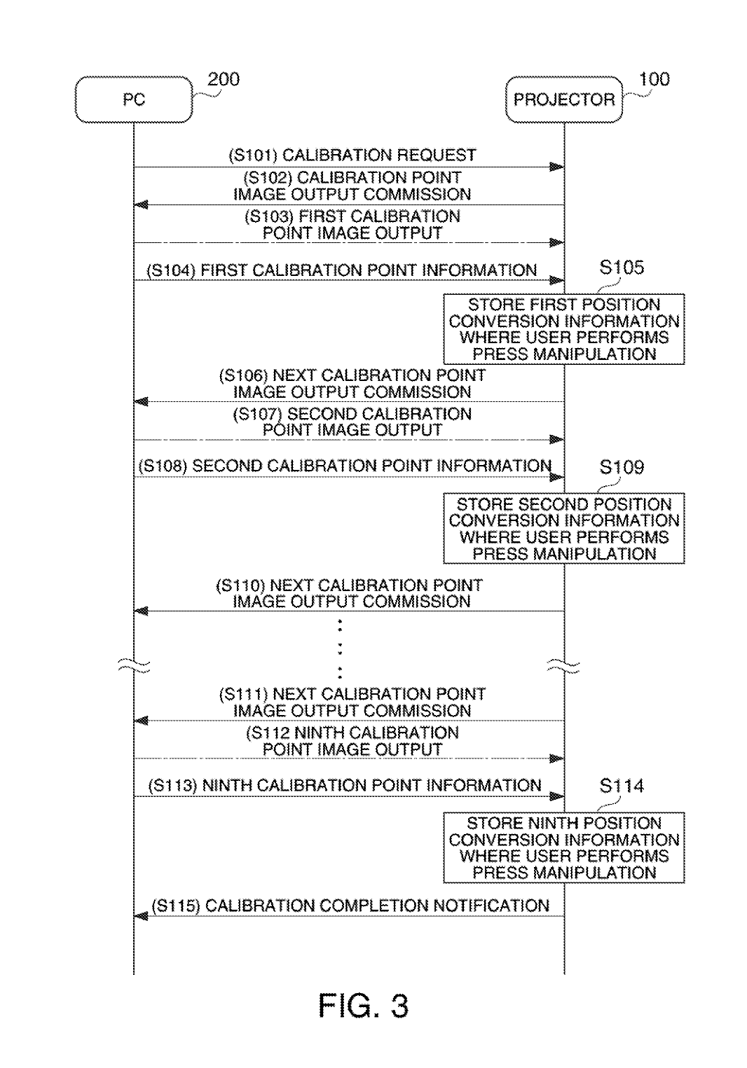

FIG. 3 is a sequence diagram of the PC 200 and the projector 100 in calibration.

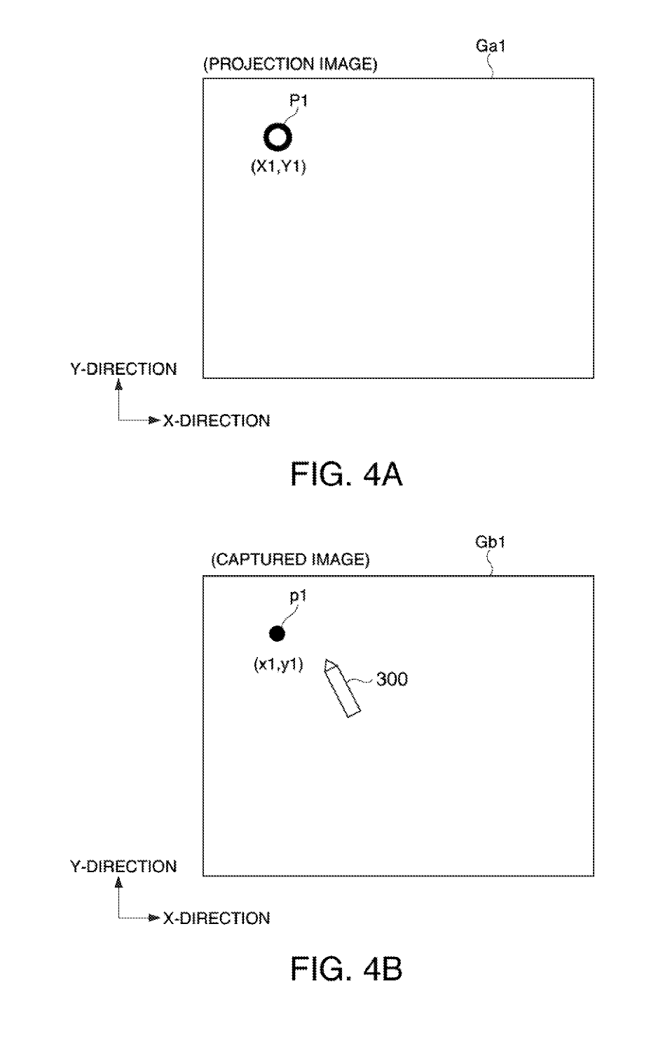

FIGS. 4A and 4B are each an explanatory diagram of an image in calibration, in which FIG. 4A is an explanatory diagram of a projection image of a first calibration point and FIG. 4B is an explanatory diagram of a captured image at the time of first calibration.

When a user instructs the execution of calibration using an input device (not shown) of the PC 200, the PC 200 sends a calibration request to the projector 100 as shown in FIG. 3 (Step S101). Upon receiving, by the conversion control section 52, the calibration request via the communicating section 54 of the projector 100, the conversion control section 52 sends an output commission of a calibration point image to the PC 200 (Step S102). Upon receiving the calibration point image output commission, the PC 200 outputs a first calibration point image (Step S103). Here, the output of the image is indicated by a dashed-dotted line. Then, the PC 200 sends, as first calibration point information, coordinate information of a first calibration point, that is, coordinate information (hereinafter also referred to as “image signal coordinates”) on the image based on the image signal to the projector 100 (Step S104).

In this case, the projector 100 projects an image based on a signal of the first calibration point image output from the PC 200, so that a projection image Ga1 shown in FIG. 4A is projected on the projection surface S. In the projection image Ga1, a first calibration point P1 is displayed in a circular form. As shown in the drawing, when it is defined that the right direction with respect to the projection image is the +X-direction and the upper direction is the +Y-direction, the coordinate information of the first calibration point P1 is (X1, Y1) which are the coordinates of the center of the circle. When a user manipulates the light-emitting pen 300 to perform a press manipulation at the center of the first calibration point P1 on the projection surface S, the conversion control section 52 of the projector 100 detects, based on a captured image Gb1 captured by the image capturing section 51, coordinates (hereinafter also referred to as “captured image coordinates”) p1 (x1, y1) of the position where the press manipulation has been performed within the captured image (refer to FIG. 4B). Then, the conversion control section 52 makes a correspondence between the image signal coordinates and the captured image coordinates, generates first position conversion information, and causes the position conversion information storing section 53 to store the first position conversion information (Step S105).

The conversion control section 52 of the projector 100 sends a next calibration point image output commission to the PC 200 (Step S106). Upon receiving the calibration point image output commission, the PC 200 outputs a second calibration point image (Step S107). Then, the PC 200 sends, as second calibration point information, the coordinate information (image signal coordinates) of a second calibration point to the projector 100 (Step S108). Then, the conversion control section 52 generates, based on the image signal coordinates and captured image coordinates, second position conversion information, and causes the position conversion information storing section 53 to store the second position conversion information (Step S109). Then, the conversion control section 52 of the projector 100 sends a next calibration point image output commission to the PC 200 (Step S110).

With the repetitions of the calibration as described above, the conversion control section 52 of the projector 100 sends a ninth calibration point image output commission to the PC 200 (Step S111). Upon receiving the calibration point image output commission, the PC 200 outputs a ninth calibration point image (Step S112). Then, the PC 200 sends, as ninth calibration point information, the coordinate information (image signal coordinates) of a ninth calibration point to the projector 100 (Step S113). Then, the conversion control section 52 generates, based on the image signal coordinates and captured image coordinates, ninth position conversion information, and causes the position conversion information storing section 53 to store the ninth position conversion information (Step S114). The conversion control section 52 of the projector 100 sends calibration completion notification to the PC 200 (Step S115). The conversion control section 52 in performing the calibration described above corresponds to the calibration control section.

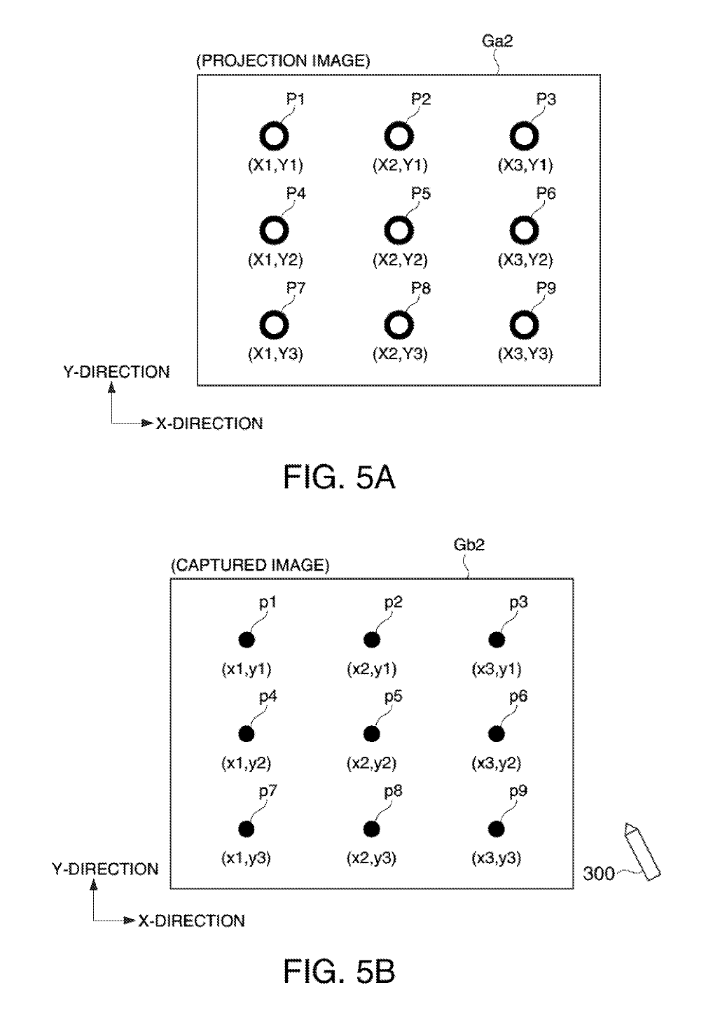

FIGS. 5A and 5B are each an explanatory diagram of an image in calibration, in which FIG. 5A is an explanatory diagram of a projection image of a ninth calibration point and FIG. 5B is an explanatory diagram of a captured image at the time of ninth calibration.

In the ninth calibration, a projection image Ga2 shown in FIG. 5A is projected on the projection surface S by the projector 100. In the projection image Ga2, circles of first to ninth calibration points P1 to P9 are displayed. In this case, the image signal coordinates of the calibration points P1 to P9 are (X1, Y1) to (X3, Y3) as shown in the drawing. When a user manipulates the light-emitting pen 300 to perform a press manipulation at the center of the ninth calibration point P9 on the projection surface S, the conversion control section 52 of the projector 100 detects, based on a captured image Gb2 captured by the image capturing section 51, captured image coordinates p9 (x3, y3) where the press manipulation has been performed within the captured image (refer to FIG. 5B).

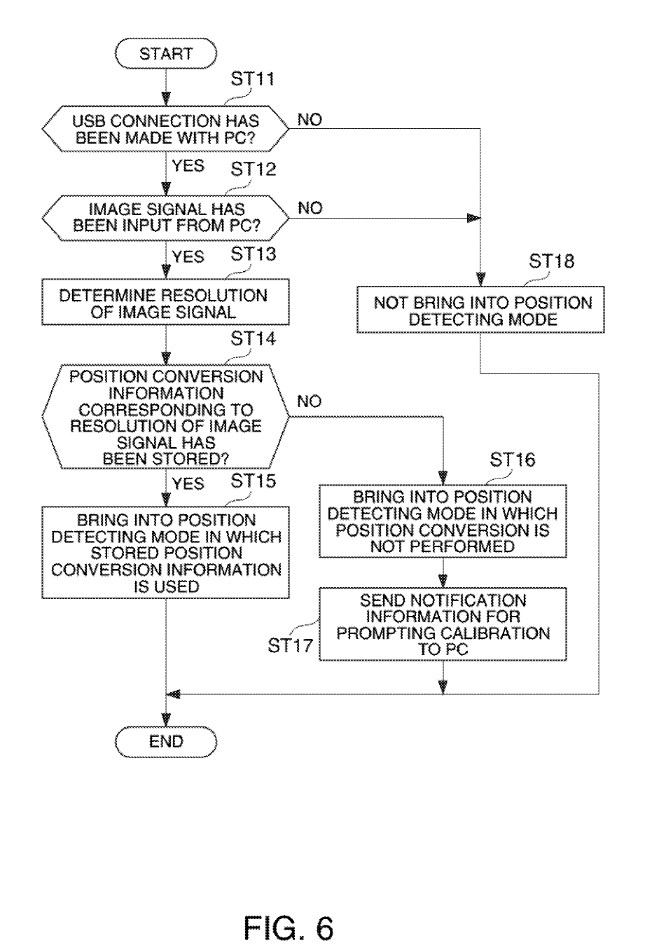

Next, a process when the interactive system 1 is activated will be described. FIG. 6 is a flowchart of the process performed by the projector 100 when the interactive system 1 is activated.

When the power of the projector 100 and the PC 200 of the interactive system 1 is turned on and software of the interactive system included in the PC 200 is activated, notification of the start of a position detecting mode is sent from the PC 200 to the projector 100, and the projector 100 starts operation of the position detecting mode in accordance with the flowchart of FIG. 6. The position detecting mode used herein means a mode (state) in which the projector 100 performs operation of analyzing a captured image, detecting a position where a manipulation has been performed with the light-emitting pen 300 to perform the position converting process, and notifying the PC 200 of converted position information.

First, the conversion control section 52 of the projector 100 determines whether or not a USB connection has been correctly made with the PC 200 (Step ST11). If the USB connection has been made (Step ST11: YES), the control section 20 of the projector 100 determines based on notification from the image signal input section 31 whether or not an image signal has been input from the PC 200 (Step ST12).

If the image signal has been input (Step ST12: YES), the control section 20 receives information of the resolution of the image signal determined by the resolution determining section 31a, and notifies the resolution input section 55 of the information. Then, the conversion control section 52 receives the information of the resolution of the image signal from the resolution input section 55 (Step ST13). The conversion control section 52 detects whether or not position conversion information corresponding to the received resolution of the image signal has been stored in the position conversion information storing section 53 (Step ST14).

If the position conversion information corresponding to the resolution has been stored in the position conversion information storing section 53 (Step ST14: YES), the conversion control section 52 brings the projector 100 into the position detecting mode in which the stored position conversion information is used to perform the position conversion (coordinate conversion) process (Step ST15). Then, the process of the projector 100 when the interactive system 1 is activated is finished.

If the position conversion information corresponding to the resolution has not been stored in the position conversion information storing section 53 (Step ST14: NO), the conversion control section 52 brings the projector 100 into the position detecting mode in which the position conversion (coordinate conversion) process is not performed (Step ST16). Then, the conversion control section 52 sends notification information for prompting calibration to the PC 200 via the communicating section 54 (Step ST17). Then, the process of the projector 100 when the interactive system 1 is activated is finished.

If the USB connection has not been correctly made (Step ST11: NO), the conversion control section 52 does not bring the projector 100 into the position detecting mode (Step ST18). Then, the process of the projector 100 when the interactive system 1 is activated is finished. Also if an image signal has not been input (Step ST12: NO), the process proceeds to Step ST18 where the process is finished without bringing the projector 100 into the position detecting mode.

As described above, when the interactive system 1 is activated, if position conversion information corresponding to the input image signal has been stored, the projector 100 is brought into the position detecting mode in which the position conversion information is used to perform the position converting process. That is, thereafter, the projector 100 performs the position conversion (coordinate conversion) process of a captured image based on the position conversion information. If the position conversion information has not been stored, the projector 100 is brought into the position detecting mode in which the position converting process is not performed.

Next, a process when the interactive system 1 executes the position converting process will be described.

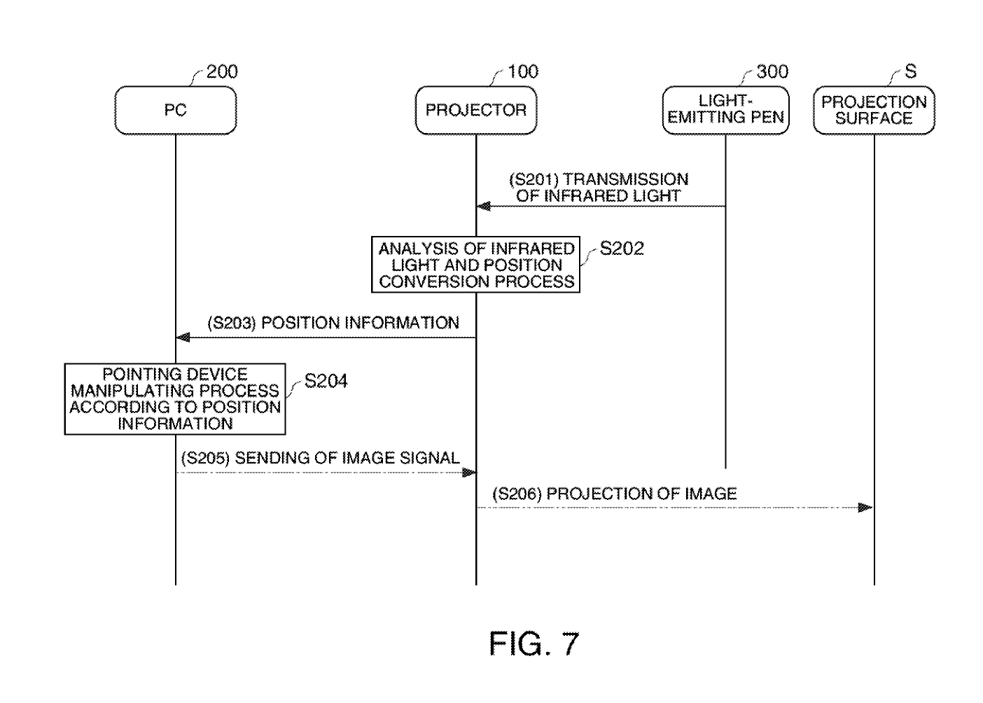

FIG. 7 is a sequence diagram when the interactive system 1 executes the position converting process.

When the press manipulation of the light-emitting pen 300 is performed by a user, the light-emitting pen 300 transmits infrared light and the projector 100 detects the infrared light through a captured image captured by the image capturing section 51 (Step S201). The projector 100 analyzes the infrared light and performs the position conversion (coordinate conversion) process based on the position conversion information stored in the position conversion information storing section 53 (Step S202).

The projector 100 sends the converted position information to the PC 200 (Step S203). Upon receiving the position information, the PC 200 performs a pointing device manipulating process according to the position information (Step S204). Then, the PC 200 sends an image signal according to the pointing device manipulating process to the projector 100 (Step S205). Then, the projector 100 projects an image based on the received image signal onto the projection surface S (Step S206).

As described above, the interactive system 1 can project an image by using a manipulation with the light-emitting pen 300 as a manipulation with a pointing device.

According to the embodiment described above, the following advantages can be obtained.

(1) In the interactive system 1, the projector 100 projects an image based on a signal of a calibration point image from the PC 200. Then, a press manipulation of the light-emitting pen 300 by a user is detected, a correspondence of position conversion (coordinate conversion) between image signal coordinates and captured image coordinates is made, and the correspondence is stored in the position conversion information storing section 53. With this configuration, calibration information can be stored. Further, since the position conversion information storing section 53 can store position conversion information corresponding to a plurality of resolutions, convenience is enhanced.

(2) If position conversion information corresponding to the same resolution as that of an image signal input from the PC 200 to the projector 100 has been stored in the position conversion information storing section 53, the interactive system 1 operates in the position detecting mode in which the position conversion information is used. Accordingly, it is no necessary to implement calibration when the PC 200 is activated, which is useful.

(3) When the PC 200 is changed to another PC, if position conversion information corresponding to the same resolution as that of an image signal input to the projector 100 has been stored in the position conversion information storing section 53, the interactive system 1 operates in the position detecting mode in which the position conversion information is used. Accordingly, if calibration is once implemented in the PC 200 having a certain resolution, and if another PC outputs an image signal of the same resolution as that of the PC 200, it is no necessary to implement calibration even when the PC 200 is changed to the PC, and therefore convenience is improved.

(4) If the position conversion information corresponding to the same resolution as that of the input image signal has not been stored in the position conversion information storing section 53, the interactive system 1 sends notification information for prompting calibration to the PC 200. Then, the PC 200 can prompt a user to perform calibration. For example, a projection screen (not shown) saying “Please perform calibration” can be displayed. With this configuration, since a user can recognize that it is necessary to implement calibration, convenience is improved.

The invention is not limited to the embodiment described above but can be implemented with the addition of various modifications or improvements. Modified examples will be described below.

### First Modified Example

In the embodiment, as calibration point information, coordinate information (image signal coordinates) on an image based on an image signal is sent from the PC 200 to the projector 100. However, information on what number the calibration point is may be sent to the projector 100. In this case, the projector 100 can recognize, based on the resolution of the image signal sent from the PC 200, coordinate information (image signal coordinates) on the image based on the image signal. Then, the conversion control section 52 of the projector 100 can make a correspondence between the image signal coordinates and captured image coordinates, generate position conversion information, and store the position conversion information in the position conversion information storing section 53.

### Second Modified Example

When the projector 100 of the embodiment includes an aspect ratio changing function by which a pixel area to be used in the liquid crystal light valves 12R, 12G, and 12B can be changed, the projector 100 may include a position conversion information storing section (not shown) which stores position conversion information for every changeable aspect ratio. When the aspect ratio is changed, position conversion information may be read from the position conversion information storing section corresponding to the aspect ratio to perform the position converting process.

### Third Modified Example

In the embodiment, the form in which a manipulation is performed on a projection image using the light-emitting pen 300 which transmits infrared light has been shown. However, the invention is not limited to the form. For example, a form in which a manipulation is performed with a laser pointer may be adopted. Further, it makes to the reflection pen as taking the place of the light-emitting pen, where the reflection pen can reflect the light from such as a projector. Further, the movement of the human-finger, as taking the place of the reflection pen, which is detected near projection surface may be adopted.

### Fourth Modified Example

In the embodiment, the number of calibration points is nine, but the number is not limited to nine.

### Fifth Modified Example

In the embodiment, the light source 11 of the projector 100 is composed of the discharge-type light source lamp 11a. However, a solid-state light source, such as an LED (Light Emitting Diode) light source or a laser, or other light sources can also be used.

### Sixth Modified Example

In the embodiment, as a light modulator of the projector 100, the transmissive liquid crystal light valves 12R, 12G, and 12B are used. However, it is also possible to use a reflective light modulator such as a reflective liquid crystal light valve. Moreover, it is also possible to use a minute mirror array device or the like which modulates light emitted from a light source by controlling the emitting direction of incident light with each micromirror as a pixel.

The entire disclosure of Japanese Patent Application No. 2011-34269, filed Feb. 21, 2011 is expressly incorporated by reference herein.

What is claimed is:

1. An interactive system comprising:
a projector;
a computer which supplies the projector with an image signal; and
a transmitter which transmits a light signal based on a predetermined manipulation, wherein
the projector includes
an image signal input section to which the image signal is input,
a light source,
an image projecting section which modulates, according to the image signal, light emitted from the light source to project the light onto a projection surface as a projection image,
a resolution determining section which determines the resolution of an image based on the image signal to output resolution information, and
a position information converter which performs, based on the image signal, conversion of information of a position where the predetermined manipulation has been performed,
the position information converter includes
an image capturing section which captures a range including the projection image to output captured image data,
a calibration control section which calculates position conversion information so as to bring a predetermined place within the projection image represented by the captured image data into correspondence with a predetermined place within the image based on the image signal,
a position conversion information storing section which stores the position conversion information resolution by resolution based on the resolution information,
a conversion control section which determines, if an image formed by the light signal is detected within the projection image included in the captured image data, that the predetermined manipulation has been performed, uses the position conversion information stored in the position conversion information storing section to convert position information representing the position where the predetermined manipulation has been performed into a position on the image based on the image signal, and outputs the position information, and
a converted position information output section which outputs the position information converted by the conversion control section, and
the computer includes an object manipulating section which manipulates, based on the position information output by the converted position information output section, an object included in the image represented by the image signal.

2. The interactive system according to claim 1, wherein
the conversion control section causes the converted position information output section to output notification for prompting the implementation of the calibration if the position conversion information corresponding to a resolution based on the resolution information has not been stored in the position conversion information storing section.

3. The interactive system according to claim 1, wherein
the position conversion information is a conversion expression for converting information of a pixel position within the projection image into information of a pixel position within the image based on the image signal.

4. A method for converting position information in an interactive system, comprising:
accepting input of an image signal;
projecting, as a projection image, an image according to the image signal onto a projection surface;
determining a resolution of the image according to the image signal;
capturing the projection image as a captured image data;
converting, so as to bring one position within the projection image by the captured image data into correspondence with second position within the image;
storing the position conversion information resolution by resolution;
wherein, if an optical signal from an object of the neighborhood of the projection surface is detected within the projection image included in the captured image data, converting third position where a predetermined manipulation has been performed into fourth position on the image using the stored position conversion information based on the determined resolution.

5. The method for converting position information according to claim 4, further comprising:
outputting notification for prompting the implementation of calibration if the position conversion information corresponding to a resolution based on the resolution information has not been stored.

6. The method for converting position information according to claim 4, wherein
the position conversion information is a conversion expression for converting information of a pixel position within the projection image into information of a pixel position within the image based on the image signal.

7. A position information converting device in an interactive system comprising:
an image signal input section to which the image signal is input;
an image projecting section which projects, according to the image signal, onto a projection surface as a projection image;
an image capture section which captures the projection image as captured image data;
a resolution determination section which determines according to the image;
a convertor which converts one position within the projection image into correspondence with second position within the image;
a memory which stores a position conversion information resolution by resolution; and
if an optical signal from an object of the neighborhood of the projection surface is detected within the projection image included in the captured image data, a conversion controller which determines a predetermined manipulation has been performed, and converts third position within the projection image where the predetermined manipulation has been performed, into fourth position on the image using the stored position conversion information in the memory based on the determined resolution.
